(19) United States
(12) Patent Application Publication
(10) Pub. No.: US 2018/0041419 A1
(43) Pub. Date: Feb. 8, 2018

(54) Virtual Router For Paths Between Autonomous-System Pairs

(71) Applicant: Console Connect Inc., Santa Clara, CA (US)

(72) Inventors: Al Burgio, Morgan Hill, CA (US); Thomas Brian Madej, Hamilton (CA); William B. Norton, Palo Alto, CA (US)

(21) Appl. No.: 15/231,080

(22) Filed: Aug. 8, 2016

(51) Int. Cl. H04L 12/715; H04L 12/46; H04L 12/725; H04L 12/24; H04L 12/721; H04L 12/707; H04L 12/713; H04L 12/26

(52) U.S. Cl. CPC H04L 45/04; H04L 45/586; H04L 12/46; H04L 12/4641; H04L 43/08; H04L 41/0273; H04L 45/70; H04L 45/22; H04L 41/0803; H04L 45/302

(57) ABSTRACT

Disclosures teach a virtual router operable to change a connection between a first Autonomous System (AS) and a second AS from a first path to a second path. The connection passes packet traffic over Intermediate Networking Infrastructure (INI) between the first AS and the second AS. The virtual router may utilize a protocol for machine-to-machine interaction to reconfigure node(s) in the INI to change the connection. In examples, the INI may include an Internet Exchange Grid (IEG) connected to a first Internet Exchange Points (IXP) and a second, geographically-remote, IXP respectively connected to the first and second ASs. The IEG may provide authentication, together with switching infrastructure, to enable a peering relationship between the first AS and the second AS. The virtual router may process measurements from the first path and the second path, potentially with different metrics, to determine to change the connection to the second path.

### FIELD OF THE INVENTION

This invention relates to computer networking and, more particularly, to the interconnection of routing domains.

### BACKGROUND OF THE INVENTION

An Autonomous System (AS), also referred to herein as a routing domain, is a collection of one or more interconnected computing networks and/or subnetworks that present a common routing policy to the internet, share one or more Internet Protocol (IP) routing prefixes, and/or are under the control of a common administrator. Although, in some cases, hosts in a first AS may communicate with hosts in a second AS over a direct link, one or more different intermediate networks, often facilitate the passing of such traffic. For example, an AS may gain access to the internet through interconnection via a previously-connected routing domain.

Often, a pair of routing domains pass large traffic volumes between one another, making it desirable to ensure a sufficiently robust path exists. Furthermore, in such scenarios, it can be desirable to provide opportunities for multiple different paths between the pair of routing domains. Interconnections can increase capacity, control of traffic, and redundancy, among other advantages. Also, since the Intermediate Networking Infrastructure (INI) between a pair of routing domains is organic and in a continual process of change, paths through the INI are subject to changes over time. Some changes may present problems, while others may present opportunities, making it desirable not only to establish multiple paths, but also to be able to switch between paths flexibly.

However, there are many obstacles to switching between, and/or otherwise utilizing such paths flexibly. Although an AS-network-level Gateway Protocol (AGP), like Boarder Gateway Protocol (BGP), may be used to advertise network routes and/or prefixes to route traffic between routing domains, actual configuration of connections between routing domains may involve agreement on monetary and/or other non-technical issues, establishing physical layer connections, and/or manual interaction with a configuration tool on the relevant routers. Establishing a connection between two routing domains is further complicated by the many different methods for establishing a path between two routing domains. These different approaches are associated with different types of advantages, limitations, and metrics for measuring traffic. Such obstacles also complicate the creation of a control mechanism for directing traffic at the inter-routing-domain level.

### BRIEF DESCRIPTION OF THE DRAWINGS

In order that the advantages of the disclosures will be readily understood, a more particular description will be rendered by reference to specific embodiments illustrated in the appended drawings, understanding that these drawings depict only typical examples and are not, therefore, to be considered limiting in scope. These drawings include:

FIG. 1 is a schematic block diagram of several different approaches to providing a path over Intermediate Networking Infrastructure (INI) between two routing domains, including: a transit network; a chain of networks; an Internet Exchange Point (IXP); a direct link; and a novel Distributed Internet Exchange Platform (DIXP), in accordance with examples;

FIG. 2 is a schematic block diagram of a virtual router used to switch paths between two routing domains over a DIXP, extending peering capabilities from a localized IXP to multiple access points on a geographically large scope, in accordance with examples;

FIG. 3 is a schematic block diagram of a virtual router used to switch a path, between two routing domains, over a chain of networks to a new path over a DIXP, in accordance with examples;

FIG. 4 is a schematic block diagram of a set of agents distributed across the INI to collect information for a virtual router about potential paths, in accordance with examples;

FIG. 5 is a schematic block diagram of a database, determination module, and implementation module associated with a virtual router to: (1) maintain topology information and/or measurements for a wide variety of paths between routing domains; (2) make determinations about paths for traffic flows; and (3) configure nodes in the INI to implement a determination, in accordance with examples;

FIG. 6 is a schematic block diagram of another exemplary database and additional functionalities supported thereby, in accordance with examples;

FIG. 7 is a schematic block diagram an implementation module operable to engage in one of various forms of machine-to-machine communication, possibly using agents distributed across the INI, to implement routing determinations for a virtual router, in accordance with examples; and

FIG. 8 is a flow chart for implementing a virtual router at an inter-routing-domain level, involving collecting on different paths over INI, analyzing the potential impact of a new path, and remotely configuring intermediate notes to implement the new path, in accordance with examples.

### DETAILED DESCRIPTION

It will be understood that components of the invention, as generally described and illustrated herein, can be arranged in a wide variety of different configurations. The following detailed description, which merely represents certain examples, is not intended to limit the scope of the claims. These examples may be understood by reference numbers to the figures. Reference numbers concluding with an additional letter, or letter-number pair, indicate differing instances of a class with the same or similar, but varying, attributes. References by number only refer more generally to the class and/or a representative instance.

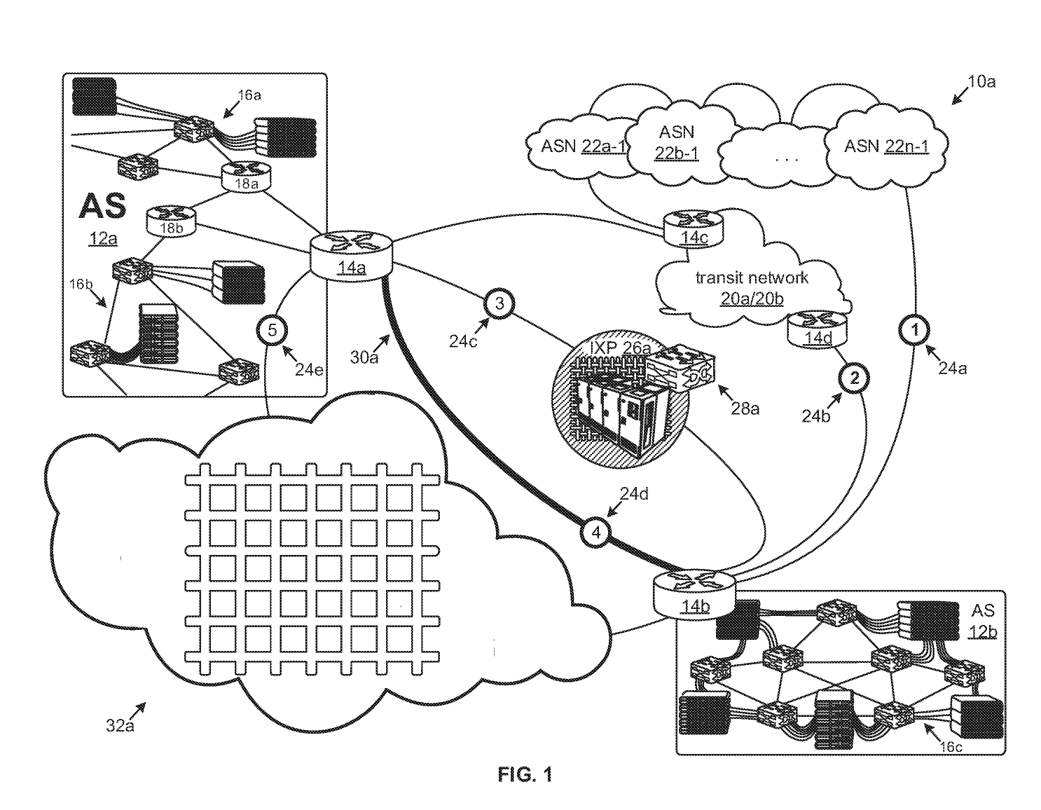

Referring to FIG. 1, Intermediate Networking Infrastructure (INI), also referred to herein as networking structure, 10a is depicted between a first Autonomous System (AS), or routing domain, 12a and a second AS/routing domain 12b. Gateway routers 14a, 14b respectively pertaining to the first AS 12a and the second AS 12b may provide access to the INI 10a. Such gateway routers 14a, 14b may implement an AS-network-level Gateway Protocol (AGP), like, without limitation, Boarder Gateway Protocol (BGP) to advertise routing and/or prefix information for traffic from and/or to other routing domains 12.

The first AS 12a comprises multiple networks 16a, 16b interconnected by routers 18a, 18b for a common enterprise. Conversely, the second AS 12b covers a single network 16c. Both, however, are consistent with the definition of an AS.

The first AS 12a, may require analysis of large data volumes it generates, but may lack the necessary infrastructure. Although lacking a direct link to the first AS 12a, the second AS 12b, which may be a datacenter 16c, may offer data-analysis services. However, traffic flows between the routing domains 12a, 12b entailed by the services may create common issues that merit the creation of a path, or connection, attuned for certain metrics including, without limitation: bandwidth; security; and/or any number of considerations. Also, several different approaches to paths/connections between routing domains 12a, 12b, with different relevant metrics, may be possible.

Some of the differences between approaches may arise from differences between transit and peering relationships. With respect to transit relationships, for example, each of the routing domains 12a, AS 12b may be a tier 3 domain or a tier 2 domain. A Tier 3 domain may be, without limitation, an enterprise-level network, one or more specialized networks, and/or a small, regional ISP. To gain internet access, a tier 3 domain often needs to pay a fee, known as settlement, to another domain, known as a transit network/domain 20, which may be a tier 1, 2, or 3 domain that already has access to the internet.

With respect to peering relationships, a tier 2 network/domain often pays settlement to another transit network/domain 20 to reach certain internet domains. However, a tier 2 network/domain is also often able to agree with other routing domain/networks 12 to mutually carry traffic for one another without cost, or significant cost, in a peering relationship. Often, in peering relationships, participating routing domains 12 may have access to one another, but not to routing domains with a second degree of separation from the participating routing domains 12. Additionally, each participating routing domain 12 retains its own revenue. According to a common standard, tier 1 domains can access most any other network/domain on the internet without paying settlement.

In addition to settlement costs, or lack thereof, transit and/or peering relationships may impose different requirements, in the form of routing policies, which may have implications for deciding between traffic paths. In the context of considerations surrounding transit and peering relationships, a discussion may commence as to various, non-limiting approaches, depicted in FIG. 1, to establishing paths/connections between routing domains 12a, 12b.

For example, according to a first approach, the first AS 12a may, as a third tier domain, pay settlement to a second-tier transit network/domain 20a. However, consistent with the second-tier status, the transit network/domain 20a may not have direct access to the second AS 12b. However, the transit network/domain 20a may have access, such as through a transit or peering relationship, to another intermediate network/domain 22a, which may pertain to a chain of any number of intermediate network/domains 22a-22n. The final intermediate network/domain 22n in the chain 22a-22n may provide access to the second AS 12b, thereby making possible a first path 24a, indicated by the circled number 1 in the figure, between the routing domains 12a, 12b.

In such examples, the path, or route, 24a of the traffic is subject to the control of not only the first transit network/domain 20a, but also the chain of intermediate network(s)/domain(s) 22a-22n, outside the control of a common entity. Consequently, for such paths 24, costs, services, and/or performance metrics are subject greater variability, creating barriers to guarantees for Quality of Service (QoS) for sensitive traffic.

These limitations may be addressed with a second approach in which the first AS 12a enters a transit relationship with a second exemplary transit network/domain 20b with direct access to the second AS 12b. The second exemplary transit network/domain 20b may be, for example, a first tier domain able to access most networks without paying settlement.

In such scenarios, the transit network/domain 20b may handle traffic internally along a second path 24b, indicated by the circled number 2. The transit network/domain 20b may control traffic directed between its gateway routers 14c, 14d with internal switches, routers, and or the like that may be connected to one another and/or a network controller. Consequently, the transit network/domain 20b may offer certain guaranties with respect to QoS and/or the like. However, the first AS 12a and/or second AS 12b may pay a premium in settlement and/or be subject to burdensome routing policies, which may or may not be justified, depending on the nature of the traffic and/or alternative options.

A third approach for a third path 24c, indicated by the circled number 3, may make use of an Internet eXchange Point (IXP) 24a. An IXP 24a may provide a switch, or system of switches, 28a to which routing domains 12a, 12b participating in the IXP 20 may connect. Furthermore, the IXP 26a may operate a layer-2 configuration and/or may utilize an Internet Protocol (IP) subnet for the connection of participating ASs 12. Two participating routing domains 12a, 12b may utilize their connections, therefore, to engage in a peering session, as opposed to paying settlement. Examples of such an IXP 26 may include a data center or collocation center, where the costs may be shared by participants. However, IXPs 26 are limited in the peering they can facilitate by their physical location.

As an example of a fourth approach, which may overcome geographic limitations and/or tailor a path 24d to the needs of routing domains 12a, 12b, a private communication link 30a may be installed, creating a fourth path 24d indicated by the circled number 4, the two routing domains 12a, 12b. The private communication link 30a may be, without limitation, copper and/or fiber-optic cabling, microwave channels, and/or satellite links. Even more so than with the transit approaches, this fourth approach can be expensive, especially where long distances and/or large bandwidths are involved, and only provides a path 24d between two routing domains 12a, 12b.

As can be appreciated, these different approaches do not share common metrics, and each has its tradeoffs. A fifth approach, which may provide a fifth path 24e indicated by the circled number 5, may provide further options, which may combine many advantages, with few disadvantages, of previous approaches. This new approach is described in further detail with the following figure and is referred to herein as an Internet Exchange Grid (IEG), a grid of IXPs, or a Distributed Internet Exchange Platform (DIXP), 32a.

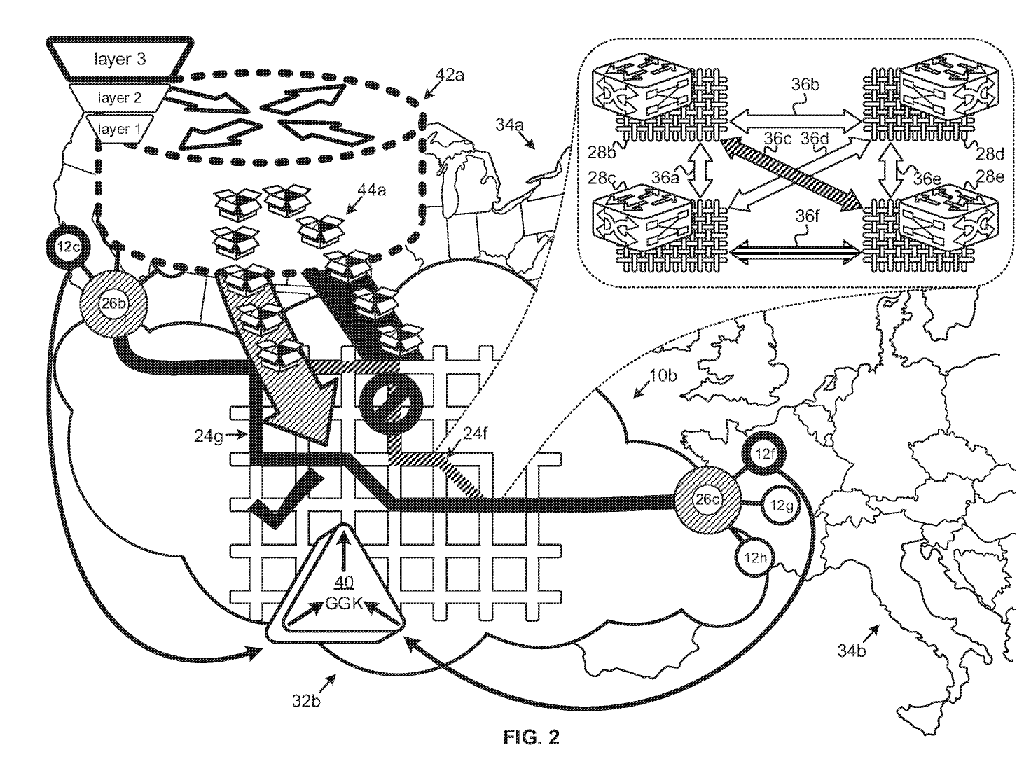

Referring to FIG. 2, an IEG/DIXP 32b is depicted, highlighting its advantages in implementing peering relationships irrespective of the geographic location of the participating routing domains 12c-12h. As depicted, peering relationships may be entered into even where routing domains 12c-12h are remotely located on different continents 34a, 34b.

An IEG/DIXP 32b, within the INI 10b, may interconnect a set of multiple IXPs 26b, 26c at different geographic locations. As used herein, a ‘set’ may include any number of elements including one element and no elements. The IEG/DIXP 32b may include a number of routers, switches, cloud infrastructure, and/or the like providing nodes in a mesh, or other topology, operable to carry traffic between routing domains 12c-12h, such as an AS 12c in San Francisco and an AS 12f in Paris. The first routing domain 12c and the second routing domain 12f may respectively connect, or be communicatively coupled, to a first IXP 26b at a first geographic region, or physical location, and a second IXP 26c at a second geographic region, or physical location, geographically remote from the first region/location. The first and second IXPs 26b, 26c may, in turn, be connected by the IEG/DIXP 32b, which may provide physical packet-switching infrastructure 26 between the first IXP 26b and the second IXP 26c.

As depicted, different traffic paths 24f, 24g are possible between the two IXPs 26b, 26c to which the two remotely located routing domains 12c, 12f are connected. Although two paths 24f, 24g are depicted, any number of different paths 24 are possible. The variety of routes 24 is further highlighted by the inset depiction of an enlarged portion of the IEG/DIXP 32b, for which multiple instances of switching fabric 28b-28e are depicted with a wide range of bidirectional links 36a-36f between instances 28b-28e highlighting the possibilities for paths 24.

In addition to the physical connections for traffic in the data plane, connections between routing domains 12c-12h rely on routing information, authentication to insure reliability of the routing information, and or the like, as may be provided in the control plane. To meet such needs, a set of Gate Keepers GK, which may include a Global Gate Keeper (GGK) 40, may be included for execution on a set of processors in the IEG/DIXP 32b. The GGK 40 may be operable to authenticate the first AS 12c to make connections across the IEG/DIXP 32b with a set of authenticated ASs 12d-12h. Hence, a GGK 40 may authenticate the first AS 12c and the second AS 12f to pass traffic over the physical packet-switching infrastructure 32b along a new path 24g according to a peering relationship. Also, to facilitate such paths 24g, 24f, the GGK 40 may run an inter-autonomous-system-routing protocol, such as, by way of example and not limitation, a Border Gateway Protocol (BGP) to import and/or export/advertise network prefixes and/or routing information to and/or for routing domains 12c-12h.

One or more routers 14 pertaining to multiple routing domains 12c-12h connecting to the IEG/DIXP 32b, regardless of their geographic location, may connect, or establish a session with, a GGK 40. By way of example, and not limitation, an AS 12c may connect with a GGK 40 by establishing a BGP session with the GGK 40. Once authenticated, the geographically-dispersed routing domains 12c-12h may also advertise net prefixes and/or routing information by one or more GGKs 40. Other geographically-dispersed routing domains 12c-12h may receive and/or trust network prefixes and/or routing information advertised by geographically-dispersed routing domains 12c-12h connected to and/or authenticated by a corresponding GGK 40. In some examples, the set of Gate Keepers (GK) than may include one or more Local Gate Keepers that may provide similar functionality for localized subsets of the IEG/DIXP 32b.

Hence, a GGK 40 may allow for multilateral peering sessions between multiple routing domains 12c-12h, requiring minimal configuration at corresponding routers. The routing domains 12c-12h connected to and/or authenticated by a corresponding GGK 40 may, therefore, form a Virtual Local Area Network (VLAN) providing packet-switching infrastructure to communicate traffic between the set of IXPs 26b, 26c for a set of ASs 12c-12h authenticated by the GGK 40, enabling a peering relationship between the set of authenticated ASs 12c-12h. Further explanation of IEG/DIXP technology may be found in U.S. Pat. No. 9,246,766, entitled “Method and Apparatus for a Distributed Internet Architecture,” which is incorporated herein by reference.

Advantageously, the IEG/DIXP 32b may lower peering barriers and/or provide alternative paths 24 for remote routing domains 12c-12h. The control plane, not only of the IEG/DIXP 32a/32b, but of additional Intermediate Network Infrastructure (INI) 10b, may also be used to collect data on different potential paths 24 between routing domains 12c-12h. With such information, responsive decisions may be made to better utilize the INI 10b. To facilitate such determinations, appropriate data sets, informed by the nature of the various approaches to connecting routing domains 12, particularly in light of the peering relationships enabled by DIXP technologies 32, may be provided.

As can be appreciated from the discussion of the first two figures, different types of paths 24 may be utilized between routing domains 12. Which of these paths 24 best meets the needs of a pair of routing domains 12 may vary over time. To respond to information about changes, a virtual router 42a may be implemented at the networking layer, or layer 3. For example, information may indicate a new path 24g, or improved performance along a second path 24g relative to a first path 24f for a flow of packets 44a from the first AS 12c to the second AS 12f. In response, the virtual router 42a may stop the flow 44a along the first path 24f and may route the flow 44a along the second path 24g. However, for a variety of considerations, such as the different nature of potential paths 24, implementation of such a virtual router 42a presents difficulties.

The following discussion provides a brief, non-limiting overview of implementation examples for virtual routers 42. Either within the virtual router 42 or otherwise communicatively coupled to the virtual router 42, a database may be maintained on a storage medium. The database may include path information/data for Intermediate Networking Infrastructure (INI) 10 between a first AS 12 and a second AS 12. Additionally, the virtual router 42, which may be executable from memory by one or more processors, may be communicatively coupled to the INI 10.

The virtual router 42 may include a receive module and an implementation module. The receive module may be operable to receive instances of path information. The received information may be collected by a set of agents operable to collect path data at a set of networking nodes in networking structure 10 between multiple routing domains 12, including the first AS 12 and the second AS 12. A path module may be included in some examples, which may be operable to correlate the current path information in the database to topology information about the INI 10.

The implementation module may be operable, responsive to current path information, to reconfigure one or more network nodes in the INI 10 to change traffic from a first path 24 between the first AS 12 and the second AS 12 over the INI 10 to a second path 24 between the first and second ASs 12. Even though the virtual router 42 may be physically implemented remotely, for example and without limitation on cloud infrastructure, from the one or more network nodes, it may still remotely reconfigure one or more network nodes. In some examples, the virtual router 42 may include a determination module operable to process path information in the database, applying one or more algorithms to make a determination, indicated to the implementation module, to change the path.

The INI 10 may include an IEG/DIXP 32. In such examples, the current path information in the database may include node information with which to direct the traffic along the first path 24, which traverses the INI 10 outside of the IEG/DIXP 32, and the second path 24, which traverses the INI 10 within the IEG/DIXP 32. Also, the implementation module may be operable to redirect, with the node information, the traffic from the first path 24 to the second path 24, in response to the current path information.

Similarly, the current path information in the database may include node information for the INI 10 with which to direct traffic between the first AS and the second AS along the first path 24, having a first set of traffic-handling implications, and the second path 24, having a second set of traffic-handling implications. In such examples, the determination module, trigger module, and/or an analysis module may be operable to determine to change the traffic between the first AS 12 and the second AS 12 along the first path 24 to the second path 24. The implementation module may be operable to utilize the node information to change the traffic between the first AS 12 to the second AS 12 along the first path 24 to the second path 24, in response to the current path information. Furthermore, additional aspects and additional details for a virtual router 42 are set forth in greater detail below, with the help of the following drawings.

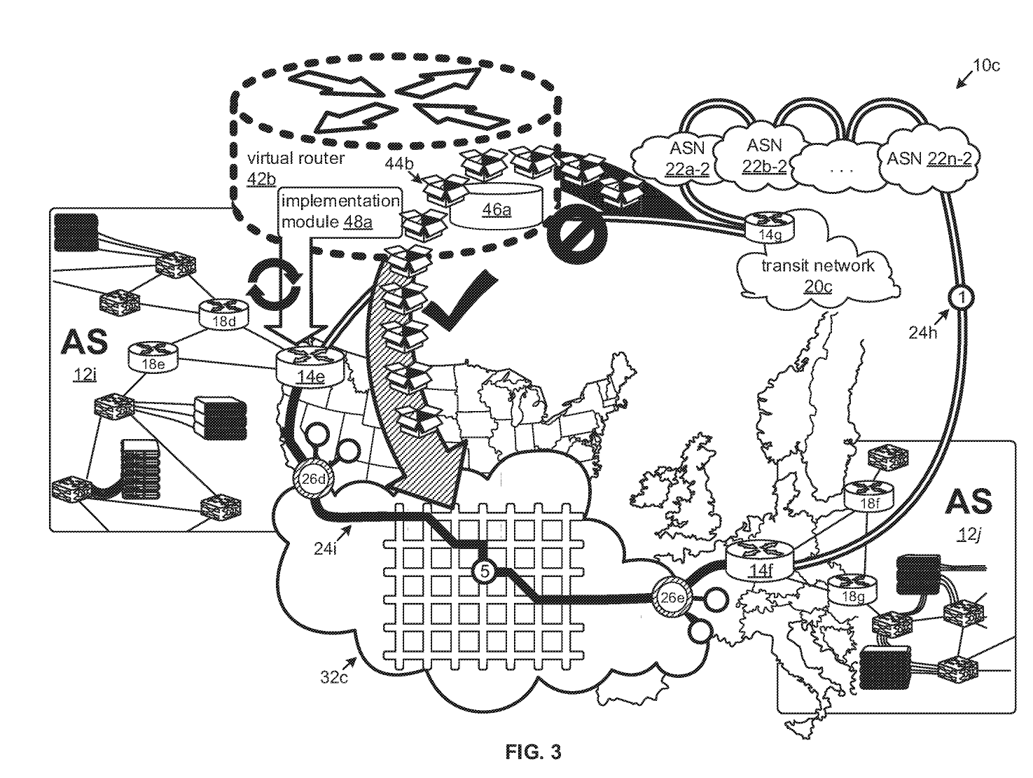

Referring to FIG. 3, a virtual router 42b is depicted. The virtual router 42b is depicted blocking a flow of packets 44b over a transit network/domain 20c and a chain of intermediate routing domains 22a-2-22n-2 between a first AS 12i and a second AS 12j. However, the virtual router 40b may be operable to provide such routing services for any number of pairs of routing domains 12, including large numbers of routing domains 12, that may register, or subscribe, for such services. The virtual router 42b may include a database 46a and/or an implementation module 48a.

Much of the structure and functionalities disclosed herein, may be provided by modules. Modules may be embodied in hardware, software, or an interfaced combination of both, with, without limitation, firmware, resident software, micro-code, and/or the like. Aspects of the disclosure may take the form of a computer program product embodied in any tangible, computer-readable medium for use by an instruction execution system, apparatus, or device, such as a micro-processor, Central Processing Unit (CPU), and/or the like. Without limitation, a computer-readable medium may include a portable computer diskette, a hard disk, a Random Access Memory (RAM) device, a Read-Only Memory (ROM) device, an Erasable Programmable Read-Only Memory (EPROM or Flash memory) device, a portable Compact Disc Read-Only Memory (CDROM), an optical storage device, and/or a magnetic storage device. Computer program code may be written in any combination of programming languages, including object-oriented languages, such as C++, and/or conventional procedural languages, such as the “C.”

The virtual router 42b may also redirect the flow 44b to a second path 24i along an IEG/DIXP 32c within the INI 10c, enabling a peering relationship between the first and second ASs 12i, 12j. In the figure, the virtual router 42b may act in response to path information from the database 46a to redirect the flow of packets 44b. One example of path information may include second path data correlated to the alternative path 24i including an indication that the second AS 12j has connected to a second IXP 26e of the IEG/DIXP 32c and has been authenticated by the set of GKs 40 for access to the switching infrastructure 28, enabling the peering relationship over the alternative path 24i.

As appreciated, metrics for the two paths 24h, 24i may differ. A first set of metrics for the first path 24h may include metrics for monetary cost for the traffic traversing a transit network 20c along the first path 24h, within the INT 10c, between the routing domains 12i, 12j and/or a set of conditions for the transit network 20c. Owing to a chain of intermediate routing domains 22a-2-22n-2 outside the control of the transit network/domain 20c, a unique set of performance metrics for the first path 24h may be utilized. For example, values for performance metrics may be collected indirectly, such as by way of measuring lag time, drop rates, and/or the like for data communicated between the routing domains 12h, 12i. However, the divided control of the networks 20c, 22a-2-22n-2 mitigates against any QoS metrics.

Conversely, with respect to the second path 24i, the IEG/DIXP 32c may be under common administration, allowing for QoS guarantees. The IEG/DIXP 32c is connected to a first and second IXP 26d, IXP 26e, which in turn are connected respectively to the first and second AS 12i, 12j. Unlike the hardware of the transit network/domain 20c and intermediate routing domains 22a-2-22n-2, hardware of the IEG/DIXP 32c may be commonly administered and give access to the virtual router 42b. A set of metrics for the second path 24i may, therefore, include indicators for hardware health.

Despite differences between the first and second sets of metrics relevant to the two paths 24h, 24i, the virtual router 42b may employ algorithms to analyze values from the current path information pertaining to both the first and second sets of metrics for the first and second paths 24h, 24i respectively. Furthermore, despite these qualitative differences, the virtual router 42b may determine to change the traffic between the first and second ASs 12i, 12j from the first path 24h to the second path 24i.

The virtual router 42b may access current path 24h information that includes node information to direct the traffic along the first path 24i, traversing the INI 10c outside the IEG/DIXP 32c. Such node information may include, without limitation, an IP address for a gateway router 14e of the first AS 12i and/or for the gateway router 14g of the transit network/domain 20c. To direct traffic from the first path 24h, the virtual node 42b may insure that a routing table of the gateway node 14e of the first AS 12i indicates that traffic with a destination IP address within the second AS 12j is routed to the gateway router 14g of the transit network/domain 20c.

Also, the virtual router 42b may have access to path information for the second path 24i that may also include node information for the second path 24i. Such node information may include, without limitation, an IP address for a gateway router 14e of the first AS 12i and/or an for the IXP 26d connected to the IEG/DIXP 32c. In response to an indication in the current path information to redirect the flow of packets 44b to the second path 24i, the implementation module 48a, with this node information, may change a routing table of the gateway node 14e of the first AS 12i to indicate that traffic with a destination IP address within the second AS 12j be routed to an IP address of the IXP 26d. Hence, the implementation module 48a may change a connection for traffic between the first and second AS 12i, 12j following the current path 24h to the alternative path 24i. However, the actions taken by the virtual router 42b to change to the alternative path 24i are taken in response to recent updates to the current path information. Therefore, a question arises as to the origin of such updates.

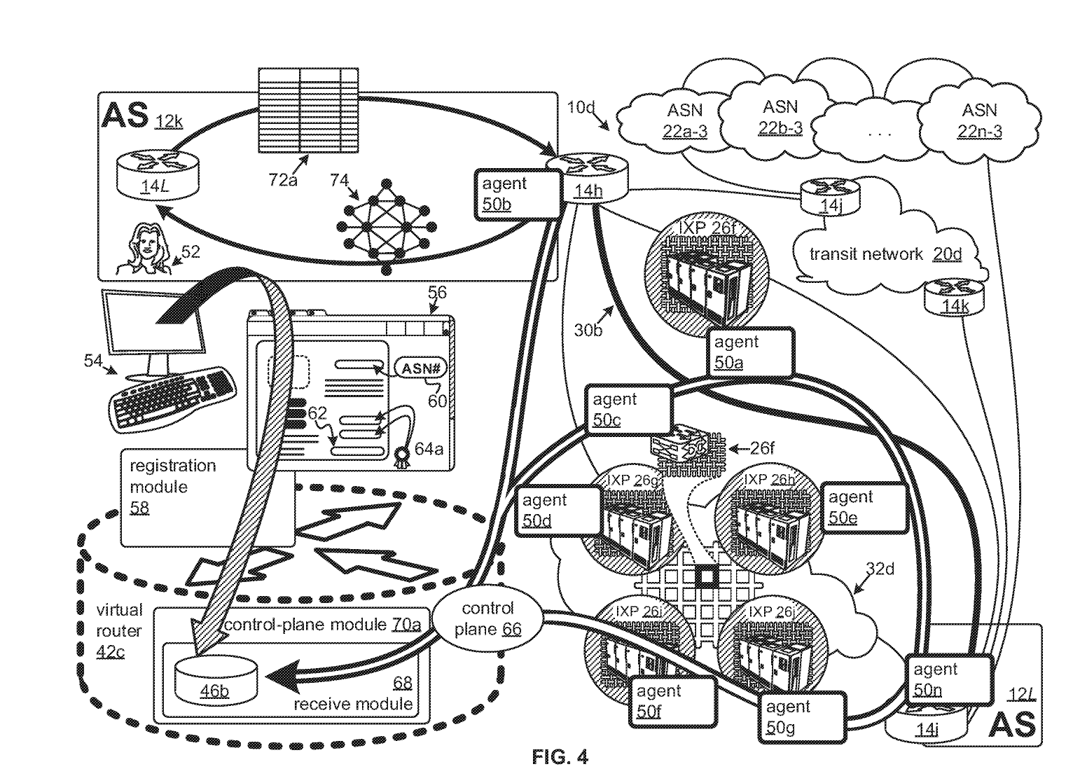

Referring to FIG. 4, a set of agents 50a-50n is depicted, implemented at a set of network nodes throughout the INI 10d, and communicatively coupled to the virtual router 42c. Individual agents 50a-50n in the set may be operable to collect instances of path information from the set of network nodes in the INI 10d and send collected path information to the virtual router 42c.

Although agents 50a-50n are distributed throughout the INI 10d, agents 50 may not be located within routing domains 20d, 22a-3-22n-3 outside the administrative scope of the virtual router 42c and/or routing domains 12k, 12L subscribing to services of the virtual router 42c. The transit network/domain 20d and the chain of intermediate routing domains 22a-3-22n-3 may be separately administered, preventing placement of agents 50 therein. Conversely, the same entity administering the virtual router 42c may have access to a stand-alone IXP 26f at which agents 50a may be located.

Because the entity administering the virtual router 42c may also administer an IEG/DIXP 32d, agents 50c may be located at instances of switching infrastructure 28f therein. Agents 50d-50g may be located with one or more IXPs 26g-26j connected to the IEG/DIXP 32d. Additionally, when an administrator 52 of a routing domain 12k subscribes to services of the virtual router 42c, it may also provide routing information for and access to a gateway router 14h, allowing for placement of an agent 50b with the gateway router 14h.

The administrator 52 may sign-up, register, and/or otherwise subscribe a routing domain 12k using a console and/or other computing device 54 to access a webpage, or website, 56 associated with the virtual router 42c. The webpage/website 56 may be maintained by a registration module 58, incorporated with the virtual router 42c and/or otherwise associated therewith. The registration module 58, which may be accessible over the internet and hosted on one or more servers, may solicit input which the virtual router 42c may utilize to route traffic to and/or from the routing domain 12k being registered.

Non-limiting examples of such information may include: an Autonomous System Number (ASN) 60; routing addresses, prefixes, protocols, and/or other routing information 62; and/or conditions 64 for peering, transit, and/or other relationships with other domains 12. The registration module 58 may then record, store, and/or maintain this information in the database 46b of the virtual router 42c and/or another database accessible by the virtual router 42c. Additionally, teachings about the collection of information during registration are disclosed by FIG. 3 and accompanying discussion of U.S. patent application Ser. No. 14/713,783, entitled “AUTOMATED NETWORK PEERING IN A SOCIAL-NETWORK MODEL,” and incorporated herein by reference.

Owing to the different nature of the various approaches to creating paths 24 between routing domains 12k, 12L, agents 50a-50n may collect measurements and/or information for many qualitatively distinct metrics, including information about changes in the topology of the INI 10d. Therefore, agents 50 may be designed for general utility to collect measurements across a wide range of metrics. Additionally, or in the alternative, agents 50 may be tailored to collect information for metrics relevant to a given type of path 24.

Consequently, in collecting measurements, the agents 50a-50n may collect measurements for a first set of metrics tailored to a first method for creating a connection between the first AS 12k and the second AS 12L over an existing path 24. Similarly, the agents 50a-50n may collect measurements for a second set of metrics tailored to a second method for a new path 24. As discussed above, the first set of metrics may differ from the second in as much as the first method for the first path 24 may differ from the second method. With reference to the first figure, but without limitation, the first and/or second methods may use: a transit network 20; a first transit network 20 and an additional network 22; a localized IXP 26; a direct connection 30; and a grid of IXPs 32.

Agents 50a-50n may then provide measurements to the virtual router 42c over a control plane 66 via a control plane module 54. As can be appreciated, the control plan 66 may include multiple control planes for different networks that may be integrated and/or generalized in a unified control plane 66 to relay measurements/information to the virtual router 42c. A receive module 68 of the virtual router 42c may be operable to communicate with the control plane 66 and combine new instances of path information/data, from agents 50a-50n, with path information/data in a database 46b, updating the database 46b to provide current path information/data. Just as traditional routers 14h, 14L use a dynamic routing protocol to exchange information about destination addresses, routing tables 72, and/or topology 74, the agents 50a-50n may provide path information/data with measurements and/or topology information to a virtual router 42c about the INI 10d and potential paths 24. Further explanation of information collection from the INI 10d is found in U.S. patent application Ser. No. 14/985,120, entitled “DATA MONITORING/AGGREGATION FOR EVALUATING CONNECTIONS BETWEEN NETWORKS,” which is incorporated herein by reference.

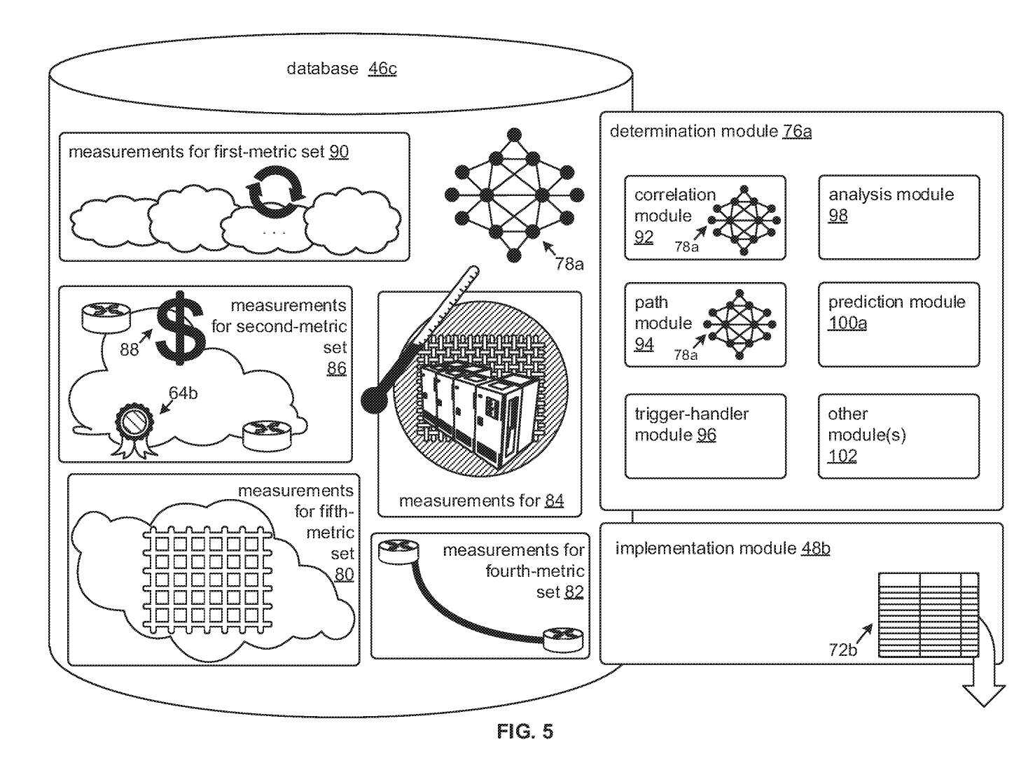

Referring to FIG. 5, an exemplary database 46c upon which a virtual router 42 may rely for path information/data, is depicted, illustrating the wide range of metrics/information that a determination module 76a may take into account. The database 46c may reside on a physical storage medium, including, without limitation, one or more RAM device(s), solid state memory devices, and/or hard drives. Such information may include topology information 78a about INI 10 and/or measurements for many different metrics. Topology information 78a may include, without limitation, information about nodes in the INI 10 and/or links between nodes, and/or available bandwidth.

Additionally, topology information 78a may include information about a path 24 over INI 10 for which the virtual router 42 may not have topology information and/or access to networking nodes therein. Examples of such routing domains may include a transit network/domain 20 and/or a chain of intermediate network/domains 22a-22n. Information about paths 24 over such infrastructure may include a list of routing domains 12 accessible thereby and/or qualitative information about path types.

Furthermore, path information about new connections between nodes and/or routing domains 12 within and/or connected to the INI 10 may update topology information 78a. Consequently, when a second AS 12 establishes a connection with an IEG/DIXP 32 connected to the first AS 12, an agent 50 at the IEG/DIXP 32 may collect this information. The receive module 68 may then enter it into the database 46c to update topology information 78a.

Measurements in the database 46c may pertain to a variety of metrics that may differ, as discussed, based on the type of path 24 for which they are gathered. For example, measurements 80 for a set of metrics for the fifth type of paths 24 through an IEG/DIXP 32, characterized by peering relationships of unlimited geographic scope, may include, without limitation, a number of hops, bandwidth, lag time, QoS guarantees, jitter, packet loss, and/or the like. Additional, non-limiting examples may include measurements for metrics about hardware health, such as hardware status, available routing memory, power-supply status, fan status, CPU temperature, hardware temperature, ambient temperature, and/or the like. Additionally, measurements 80 for the metrics may be maintained for nodes and/or other elements of the IEG/DIXP 32 not yet incorporated in a path 24, for exploring potential alternative paths 24.

Measurements 82 for a set of metrics for a fourth type of paths 24 through a private communication link 30 may include metrics about bandwidth, reliability, and/or maintenance costs. Additionally, metrics for a potential path over a private communication link 30 may include costs to establish the link 30.

Measurements 84 for a set of metrics for a third type of paths 24 over a standalone IXP 26 may include metrics for bandwidth, lag time, QoS, packet loss, jitter, and/or the like. Such metrics may also include metrics relevant to hardware health for the IXP 26, such as those discussed above and/or metrics for “global health,” such as, ambient temperature at the IXP 26, as indicated by the thermometer icon.

Measurements 86 for a second type of paths 24 over a transit domain/network 20 may include metrics about settlement costs 88, as indicated by the dollar icon. Another non-limiting examples include QoS guaranties, transit-agreement provisions, and/or the like 64b. Since the transit domain/network 20 may not be under common administration with the virtual router 42, an AS 12 with a path/connection 24 over the transit domain/network 20 may provide such information upon registering with the virtual router 42 for inter-AS routing, possibly via a web, or mobile, application 56 associated with the virtual router 42. This may also be the case for other measurements of other sets of metrics for other path types.

Measurements 90 for a set of metrics for a first type of paths 24 over a chain of intermediate network/domains 22a-22n may include metrics collected indirectly, such as by way of routing domains 12 connected over the chain 22a-22n measuring data communicated between each other, as indicated by the icon with the circling arrows. In such examples, agents 50 at gateway routers 14 for the routing domains 12 may collect measurements by, without limitation, ping and/or traceroute methods. Consequently, the database 46c may be operable to maintain data for different metrics specific to different path types having a potential to facilitate traffic passing between domains 12.

The determination 76a module may be operable to access topology information 78a, path information, measurements 80-90, and or the like from the database 46c to determine paths 24 for one or more pairs of routing domains 12. For example, the determination module 76a may process the information for the current path 24, which may include information about a set of links in the INI 10 and/or a set of measurements 80-90 for metrics relevant to the current paths 24 across the INI 10 between the routing domains 12. Additionally, the determination module 76a may indicate, based on a result of processing the current path information, to the implementation module 48b to reconfigure one or more network nodes in the INI 10 to change the traffic from a first path 24 to a second path 24.

The determination 76a module may indicate routing changes automatically based on rules programmed, and/or pre-programmed, into the virtual router 42. Alternatively, or additionally, a network administrator may manually indicate routing changes. The determination module 76a may indicate routing changes based on, without limitation, information in the database 46c about cost 88, performance, guaranteed latency minimums and/or other information to dynamically select paths 24 to meet needs of each routing domain 12. In some examples, the determination module 76a may split traffic for a pair of routing domains 12 between multiple paths 24. For example and without limitation, the determination module 76a may indicate routing changes, providing lowered cost and improved traffic speed to a routing domain 12, which uses a transit domain 20 for internet access, to send some traffic through direct peering over an IEG/DIXP 32, while allowing the remaining traffic to traverse the transit domain 20.

In some examples, a correlation module 92 and/or a path module 94 may be included, which may be operable to correlate path data, received from the agents 50, to a set of paths 24 traversing the networking structure 10. Similarly, in certain examples, a trigger module 96 may be included, which may be operable to compare first path data correlated to a current path 24 to second path data correlated to an alternative path 24, the current path 24 and the alternative path 24 traversing the networking structure 10 between a first AS 12 and a second AS 12 among multiple ASs 12 for which the virtual router 42 provides inter-AS-routing services. The trigger module 96 may determine that a comparison result merits, or triggers, a change to the alternative path 24.

An analysis module 98 may provide alternative approaches to analyze the potential impact of a path change and identify an improvement for the new path 24, which may traverse the INI 10 via a second method, or path type. Additionally, a prediction module 100a and/or one or more other modules 102 may also be included to assist in the determination process. Once the determination is made, an implementation module 48b may change a connection 24 for traffic between the first AS 12 and the second AS 12 following the current path 24 to the alternative path 24.

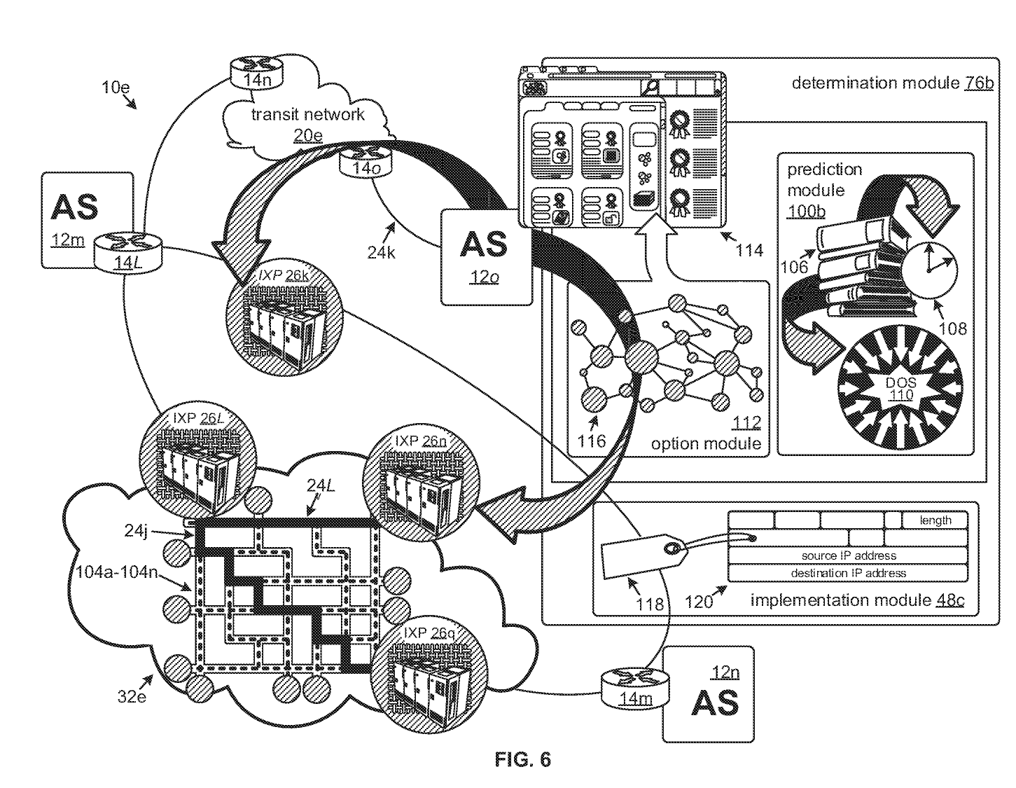

Referring to FIG. 6, another exemplary determination module 76b is depicted, to explain additional functionality that a determination module 76b may provide. For example, a path module 94 (depicted previously) of the determination module 76b may plot out different potential paths 104a-104n, indicated by the doted lines, between a pair of routing domains 12m, 12n. A prediction module 100b may then utilize historical measurements 106 to predict values for relevant metrics for one or more of the alternative paths 24 at one or more points, or ranges, of time 108 in the future, before the alternative path(s) 24 are established.

Additionally, the prediction module 100b may analyze historical measurements 106 to identify and/or predict attributes for a likely Denial of Service (DOS) attack 110. The prediction module 100b may also be operable to identify a flow of packets 44 as being part of a DoS attack 110. An implementation module 48c of the virtual router 42 may then engage to drop, reroute, and/or otherwise prevent packets so identified from being routed by the virtual router 42 to mitigate impact of the DoS attack 110. Additionally, the implementation module 48c may effect changes in the IEG/DIXP 32f to establish paths 24j, 24l therein.

As a non-limiting example of the one or more other modules 102 previously depicted, an option module 112 may be included. The option module 112 may be operable to provide notification that a given AS 12o has established a first connection or an additional connection to the INI 10e. For example, a third AS 12o may maintain a connection to the INI 10e, which may allow a first AS 12m to establish a relationship with the third AS 12o, over a transit network/domain 20e in the INI 10e. The third AS 12o may then, at a later time, establish a connection, or link, 24 with a stand-alone IXP 26k and/or an IXP 26n pertaining to an IGP/DIXP 32e. The option module 112 may then notify the first AS 12m of one or more of these new connections 24.

Not only may the option module 112 notify routing domains 12m, 12n of the connection of additional routing domains 12o to the INI 10e, but the option module 112 may facilitate the recruitment of routing domains 12 and/or the creation of additional links, or connections, to the INT 10e. For example, the option module 112 may provide a web, or mobile, application/portal/platform 114 associated with the virtual router 42, hosted by one or more servers and/or accessible over the internet and/or by a mobile device. The web, or mobile, application 114 may be incorporated with, and/or independent from, the website/webpage 56 discussed above for registering an AS 12.

The web, or mobile, application 114 may provide profiles of routing domains 12o to assist another AS 12m, 12n to make determinations about entering into traffic passing relationships, such as peering relationships, with an AS 12o based on the profile information. In some embodiments, the web, or mobile, application 114 may support a social-networking environment 116 to facilitate such connections, together with additional automation and/or other architecture disclosed by FIGS. 4 through 6 and accompanying discussion of U.S. patent application Ser. No. 14/713,783, entitled “AUTOMATED NETWORK PEERING IN A SOCIAL-NETWORK MODEL,” and incorporated herein by reference. Provided with notifications about of novel routes that become available for particular destinations, the virtual router 42 may respond. For example, the virtual router 42 may switch to using a new route 24L that becomes available if it is determined that it is more desirable than the current route 24k.

The implementation module 48c may carry out this determination. As a non-limiting example, the implementation module 48c may be operable to configure gateway routers 14L, 14m participating in a path/connection 24L over the INT 10e, to include a common label 118 in packets, and/or packet headers 120, pertaining to traffic 44 between the first AS 12m and another AS 12o. The common label 118 may be readable by a set of network nodes along a second, or new path 24L in the INI 10e to steer the packets along the path 24L. In some examples, the implementation module 48c may communicate instructions to network nodes for handling packets with various labels 118. Additional examples and/or details potential operations of an implementation module 48 are discussed with respect to the following figure.

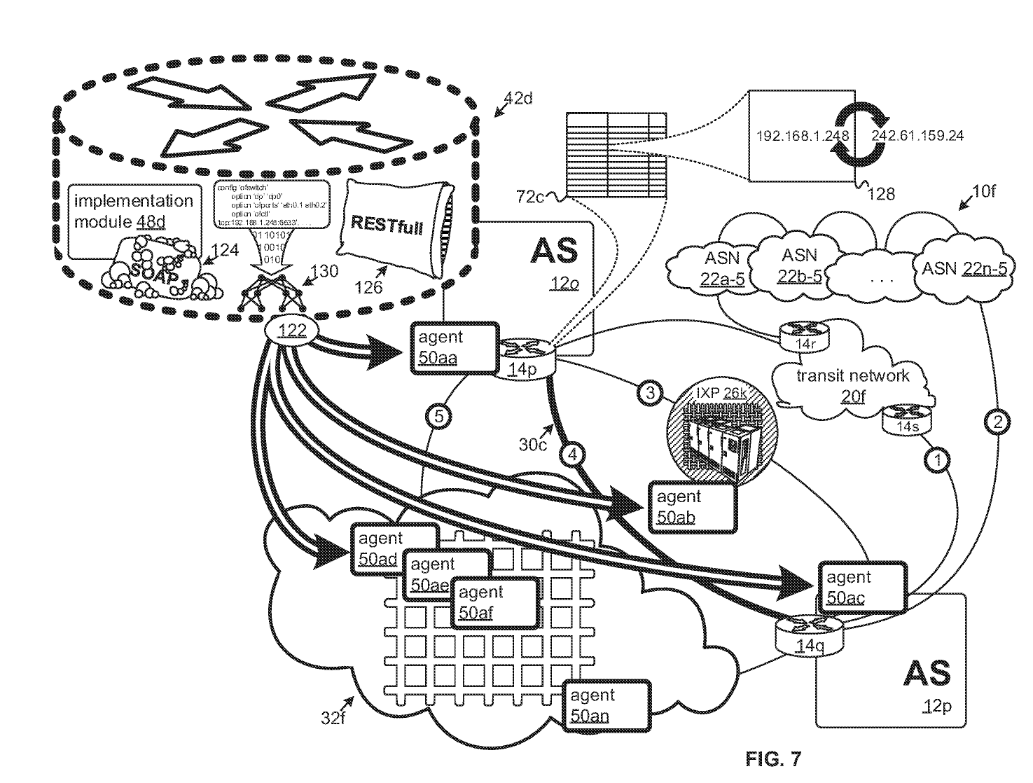

Referring to FIG. 7, an implementation module 48d is depicted within a virtual router 42d. The implementation module 48d may be operable to communicate 122 with one or more of the agents 50aa-50an distributed at different locations, such as at networking nodes, across the INI 10f. Together, the implementation module 48d and the agents 50aa-50an may constitute a control system. In some examples, one or more agents 50aa-50an may constitute may constitute existing infrastructure at corresponding network nodes. The implementation module 48d may reconfigure at least one network node to implement a change determined by the virtual router 42d.

The control system may enable machine-to-machine interaction between the virtual router 42d and at least one networking node of the networking structure 10f. In some examples, agents 50aa-50an may coincide with the agents 50a-50n discussed with respect to FIG. 4, may be a subset thereof, or visa versa. The control system may be operable to reconfigure one or more networking nodes in accordance with a protocol consistent with Simple Object Access Protocol (SOAP) 124.

Alternatively, or additionally, the control system may be operable to reconfigure networking nodes in accordance with a protocol consistent with REpresentational State Transfer (REST) 126. In some examples, such protocols 124, 126 may change 128 a destination address in one or more routing tables 72c for routers 14p and/or switches in the INI 10f. In certain examples, the implementation module 48d may rely on a Software Defined Networking (SDN) technology, such as, without limitation, OpenFlow 130.

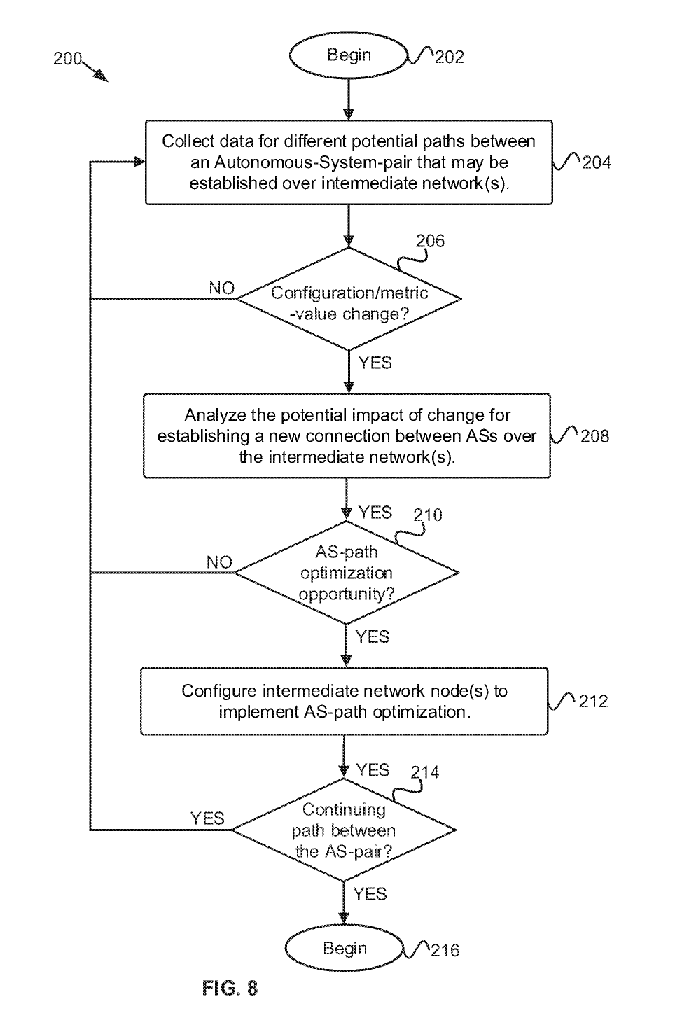

Referring to FIG. 8, a method 200 is illustrated with a flow chart for implementing a virtual router 42 at an inter-routing-domain level. The flowchart illustrates the architecture, functionality, and/or operation of possible implementations of systems, methods, and computer program products according to examples. A block, or combination of blocks, in the flowchart may represent a module, special-purpose, hardware-based system, segment, or portion of code, which comprises one or more executable instructions for implementing the specified logical function(s). It should also be noted that, in alternative implementations, the functions noted in the blocks may occur out of the order noted. In certain examples, two blocks shown in succession may, in fact, be executed substantially concurrently. Additionally, certain steps or functions may be omitted.

The method 200 may begin 202 by collecting 204 data for different paths 24 between a pair of ASs 12 over networking structure 10 between the pair of ASs 12. A determination 206 may be made as to whether there has been a change in the configuration of the networking structure 10 and/or one or more values for metrics relevant to the paths 24. If the answer is no, the method 200 may return to collecting 204 data. If the answer is yes, the method 200 may analyze 208 a potential impact for changing from an existing path 24 for a connection between the pair of ASs 12 to a new path 24.

A second determination 210 may then ask whether the configuration change(s) and/or a value change(s) present an opportunity to optimize and/or improve a connection between the pair of ASs 12 by changing the path 24. If the answer is no, the method 200 may also return to collecting 204 data. If, however, the answer is yes and the potential impact indicates an improvement, the method 200 may configure 212 one or more network nodes in the networking structure 10 to implement the connection along the new path 24.

A third determination 214 may then be made as to whether a path 24 continues between the pair of ASs 12. If the answer is yes, the method 200 may start again by returning to collecting 204 data. If the answer is no, the method may end 216 for the pair of ASs 12.

The present disclosures may be embodied in other forms without departing from their spirit or essential characteristics. The described examples are to be considered as illustrative, not restrictive. The scope of the invention is, therefore, indicated by the appended claims, not the foregoing description. All changes within the meaning and range of equivalency of the claims are embraced within their scope.

1. A system, comprising:
a database, on a storage medium, comprising path information for Intermediate Networking Infrastructure (INI) between a first Autonomous System (AS) and a second AS;
a virtual router, communicatively coupled to the database and the INI, executable from memory by a processor, and comprising:
a receive module operable to receive instances of path information; and
an implementation module operable, responsive to current path information, to reconfigure at least one network node in the INI to change traffic from a first path between the first AS and the second AS over the INI to a second path between the first AS and the second AS over the INI.

2. The system of claim 1, further comprising a determination module operable to:
process the current path information, comprising at least one of information about a set of links in the INI and a set of measurements for a set of metrics relevant to a set of paths across the INI; and
indicate, based on a result of processing the current path information, to the implementation module to reconfigure the at least one network node to change the traffic from the first path to the second path.

3. The system of claim 1, further comprising a Distributed Internet Exchange Platform (DIXP), within the INI, comprising:
a set of Internet Exchange Points (IXP) comprising a first IXP connected to the first AS at a first region and a second IXP connected to the second AS at a second region geographically remote from the first region;
a set of Gate Keepers (GK) operable to authenticate the first AS and the second AS; and
a Virtual Local Area Network (VLAN) providing packet-switching infrastructure between the set of IXPs for a set of ASs authenticated by the set of GKs, enabling a peering relationship between the first AS and the second AS along at least one of the first path and the second path.

4. The system of claim 3, wherein:
the current path information in the database comprises node information with which to direct the traffic along the first path, which traverses the INI outside of the DIXP, and the second path, which traverses the INI within the DIXP; and
the implementation module is operable to redirect, with the node information, the traffic from the first path to the second path, in response to the current path information.

5. The system of claim 1, wherein:
the current path information in the database comprises node information for the INI with which to direct traffic between the first AS to the second AS along the first path, having a first set of traffic-handling implications, and the second path, having a second set of traffic-handling implications; and
the implementation module is operable to utilize the node information to change the traffic between the first AS and the second AS along the first path to the second path, in response to the current path information.

6. The system of claim 5, wherein:
the first set of traffic-handling implications comprise values for a first set of metrics that differ from a second set of metrics for values for the second set of traffic-handling implications; and further comprising:
an analysis module, within the virtual router, operable to:
analyze values from the current path information pertaining to both the first set of metrics for the first path and to the second set of metrics for the second path; and
determine to change the traffic between the first AS and the second AS along the first path to the second path.

7. The system of claim 6, wherein the first set of metrics comprises:
a monetary cost for the traffic traversing a transit network along the first path, within the INI, between the first AS and the second AS; and
a set of conditions for use of the transit network along the first path.

8. The system of claim 6, wherein the first set of metrics comprises a set of indicators for hardware health for hardware supporting the first path.

9. The system of claim 6, wherein the first set of metrics comprises a set of Quality of Service (QoS) offerings available for traffic conducted along the first path.

10. The system of claim 6, wherein the first set of metrics comprises a set of performance metrics for traffic conducted along the first path.

11. The system of claim 1, further comprising:
a set of agents, implemented at a set of network nodes throughout the INI, communicatively coupled to the virtual router, individual agents in the set of agents being operable to:
collect instances of path information from the set of network nodes in the INI; and
send collected path information to the virtual router.

12. The system of claim 1, wherein the virtual router is:
implemented remotely from the at least one network node; and
operable to remotely reconfigure the at least one network node.

13. The system of claim 1, further comprising:
a path module operable to correlate the current path information in the database to topology information about the INI; and
a prediction module operable to predict values for a set of metrics for measuring the second path before the second path is established.

14. The system of claim 1, wherein the implementation module is operable to include a common label in packets pertaining to the traffic between the first AS and the second AS, the common label readable by at least one network node along the second path in the INI to steer the packets along the second path.

15. A method comprising:
collecting data for different paths between a pair of Autonomous Systems (AS) over networking structure between the pair of ASs;
analyzing, upon the data comprising at least one of a configuration change in the networking structure and a value change for a path metric, a potential impact for changing from an existing path for a connection between the pair of ASs to a new path; and
configuring, upon the potential impact indicating an improvement, at least one network node in the networking structure to implement the connection along the new path.

16. The method of claim 15, further comprising:
providing physical packet-switching infrastructure between a first Internet eXchange Point (IXP), to which the first AS is communicatively coupled at a first physical location, and a second IXP, to which the second AS is communicatively coupled at a second physical location, the second physical location being remotely located from the first physical location; and
authenticating the first AS and the second AS to pass traffic over the physical packet-switching infrastructure along the new path according to a peering relationship.

17. The method of claim 15, wherein:
collecting data further comprises:
collecting measurements for a first set of metrics tailored to a first method for creating a connection for passing packets between the first AS and the second AS over the existing path; and
collecting measurements for a second set of metrics tailored to a second method for creating the connection over the new path, wherein the first set of metrics differs from the second set of metrics and the first method differs from the second method, the first method and the second method being selected from a group comprising methods using: a transit network; the transit network and an additional network; a localized Internet eXchange Point (IXP); a direct connection; and a grid of IXPs; and
analyzing the potential impact further comprises identifying the improvement for the new path via the second method.

18. A system facilitating Autonomous-System communications, comprising:
a set of agents operable to collect path data at a set of networking nodes in networking structure between multiple Autonomous Systems (AS); and
a virtual router, comprising:
a correlation module operable to correlate path data, received from the set of agents, to a set of paths traversing the networking structure;
a trigger module operable to:
compare first path data correlated to a current path to second path data correlated to an alternative path, the current path and the alternative path traversing the networking structure between a first AS and a second AS in the multiple ASs; and
determine a comparison result triggers a change to the alternative path; and
an implementation module operable to change a connection for traffic between the first AS and the second AS following the current path to the alternative path.

19. The system of claim 18, further comprising an Internet Exchange Grid (IEG), within the networking structure, and comprising multiple Internet Exchange Points (IXP) comprising a first IXP, connected to the first AS at a first geographic region, and a second IXP at a second geographic region geographically remote from the first region;
a set of Gate Keepers (GK) operable to authenticate the first AS to make connections, across the IEG, with a set of authenticated ASs; and
a switching infrastructure to communicate traffic between the set of authenticated ASs and enabling peering relationships between the set of authenticated ASs, and wherein:
the second path data correlated to the alternative path comprises an indication that the second AS has connected to the second IXP and has been authenticated by the set of GKs for access to the switching infrastructure, enabling a peering relationship between the first AS and the second AS over the alternative path.

20. The system of claim 18, further comprising a control system enabling machine-to-machine interaction between the virtual router and at least one networking node of the networking structure, elements of the control system residing at both the virtual router and the at least one networking node, and the control system operable to reconfigure the at least one networking node in accordance with a protocol consistent with at least one of:
Simple Object Access Protocol (SOAP);
REpresentational State Transfer (REST); and
OpenFlow.
